(19) United States
(12) Patent Application Publication
(10) Pub. No.: US 2004/0147139 A1
(43) Pub. Date: Jul. 29, 2004

(54) Rapid energy transfer annealing device and process

(76) Inventor: Yeu-Long Jiang, Taichung (TW)

Correspondence Address: BRUCE H. TROXELL, 5205 LEESBURG PIKE, SUITE 1404, FALLS CHURCH, VA, 22041, US

(21) Appl. No.: 10/353,048

(22) Filed: Jan. 29, 2003

(51) Int. Cl. H02N 6/00

(52) U.S. Cl. 438/795

(57) ABSTRACT

Disclosed is a rapid energy transfer annealing (RETA) device and process, where an energy plate is used to rapidly absorb the primary photonic energy of the light source, such as a tungsten halogen lamp (or an xenon Arc lamp), to allow temperature elevation. The energy plate faces an amorphous thin film deposited above a glass or plastic substrate and releases the heat energy transferred by a gas or solid medium to the amorphous thin film,, so as to heat the amorphous thin film for transforming the amorphous thin film into a polycrystalline film. On another side of the glass or plastic substrate may be further provided with a heat sink plate and a supporting plate. The heat sink plate absorbs energy of the glass substrate, protects glass substrate from damages due to overheating. The heat sink plate or the supporting plate may be moved to freely adjust distance between the amorphous thin film and the energy plate and that between the glass substrate and the heat sink plate, so as to control energy transferred to the amorphous thin film and energy released by the glass substrate transfer. The adjustment of distance may be fixed or varied as a function of time so as to randomly adjust the energy transfer. Further, between the glass substrate and the amorphous film may be provided with a heat conducting layer and a heat shielding layer. On another side of the glass substrate may be provided with a heat sink layer. On the amorphous thin film may be provided with a heat absorption layer to control and allow selective crystallization, or to control direction of heat transfer thereby guiding the crystallization to grow in a specific direction.

### FIELD OF INVENTION

This invention is related to a rapid energy transfer annealing device and process, in particular to one having an energy plate capable of rapidly absorbing photonic energy, elevating temperature and releasing heat energy, and a heat sink plate capable of controlling temperature.

### BACKGROUND OF INVENTION

Increasing the driving speed of Thin Film Transistor (TFT) and improving the stability and conversion efficiency of amorphous silicon thin film solar cell are the basic requirements for the new generation TFT flat panel display and Thin Film Solar Cell. Because low temperature polysilicon (LTPS) may be integrated into a glass or a plastic substrate, and consists of electron mobility being one to two orders of magnitude higher than amorphous silicon, it can effectively improve the mobility of TFT and the stability and conversion efficiency of Thin Film Solar Cell. The LTPS has become an important material for fabricating the high driving speed of a new generation TFT flat panel display and high stability and conversion efficiency of thin film solar cell fabricated onto a glass or a plastic substrate.

In today's industry, the polysilicon film of a polysilicon TFT liquid crystal flat panel display is commonly fabricated by adopting the following two processes.

In the first process, the laser annealing process is adopted, in which a silicon dioxide buffer layer is first deposited above a glass or plastic substrate, followed by depositing an amorphous silicon film layer above the silicon dioxide buffer layer. Because near-ultraviolet (near-UV) photon energy can be effectively absorbed by the amorphous silicon, the laser annealing process applies near-UV photons emitted by a excimer laser in a short pulses mode to heat the amorphous silicon film surface and its superficial region. A rare-gas halogen excimer laser, such as ArF at 193 nm, KrF at 248 nm, or XeCl at 308 nm, is used to emit near-UV high energy photons in a short pulses mode, the amorphous silicon film surface and its superficial region can be instantly heated to a high temperature of over than 1400° C., such that the amorphous silicon film layer can be rapidly molten. The downward diffusion of the heat energy from the surface will not be too deep due to the short pulse duration. The heat shielding protection offered by the silicon dioxide buffer layer prevents softening of the glass substrate even with the diffusion of the residual heat. However, the laser annealing process involves the following disadvantages:

1. Excimer laser annealing device is extremely expensive

2. Unsteady energy density is often found among different laser emission.

3. The cost and time required for processing a large-area substrate in a scanning annealing is high.

4. Due to the grain growth stress-induced hillock at the grain boundary, parts of the regions may bulge while other parts of the regions may sink so as to result in high roughness and poor distribution at the polysilicon film layer surface.

In the second process, the furnace annealing solid phase crystallization process is adopted to anneal an amorphous silicon film layer deposited above a glass or plastic substrate in a furnace at 400° C.-600° C. for a couple of hours or more. During annealing, the amorphous silicon film layer absorbs heat energy supplied by the furnace temperature so as to slowly transform into a polysilicon film layer. However, the furnace annealing solid phase crystallization process consists of the following disadvantages:

1. The production capacity is limited due to the slow growth rate of individual crystallization regions as a result of the low temperature (400° C.-600° C.) provided by the furnace annealing.

2. Individual crystallization regions are small due to the low energy supplied at the low temperature (400° C.-600° C.), the conductivity of the polysilicon film made by the furnace annealing process is lower than that made by the laser annealing process.

A variation of the furnace annealing process is the furnace annealing metal induced crystallization or metal induced lateral crystallization process. The feature that distinguishes such features from the furnace annealing solid phase crystallization is that a metal catalyst layer is evaporated or deposited above or below the amorphous silicon film layer. Under the catalyst effects provided by the metal, the furnace temperature and annealing time required for converting the amorphous silicon film layer into polysilicon is reduced. However, the polysilicon film layer made by the furnace annealing metal induced crystallization process or metal induced lateral crystallization process consists of the same disadvantages as those made by the furnace annealing solid phase crystallization process. Further, the metal atom diffusion will result in contamination problems due to the metal residuals in the polysilicon film layer.

### DESCRIPTION OF PRIOR ART

In view of the disadvantages of the above two processes for making the polysilicon film, a conventional technique of rapid thermal annealing (RTA) that has been used to rapidly anneal amorphous silicon film. A tungsten halogen lamp is the light source of RTA. In accordance with the Wien's displacement law, λₚₑₐₖ T=constant, wherein λₚₑₐₖ is the peak wavelength, T is the absolute temperature (°K.). The peak wavelength of tungsten halogen lamp is a near-infrared (near-IR) light having a peak wavelength of approximately 1000 nm. In the rapid thermal annealing process, an intensive near-IR photons emitted from the tungsten halogen lamp directly irradiates towards the amorphous silicon film to anneal the amorphous silicon film layer into the polysilicon film. In order to effectively crystallize amorphous silicon film to polysilicon film, the temperature and the annealing time should be set exceeding 600° C. and lasting for tens of seconds. However, such temperature exceeding 600° C. and the annealing time lasting for tens of seconds surpasses the softening temperature of the glass for too long time and thus may easily cause damages to the glass substrate.

To improve the conventional rapid thermal annealing process, a pulsed rapid thermal annealing (PRTA) process that has been developed, where periodic high temperature pulses at 650° C.-850° C. are added to a background temperature within the range of 200° C.-600° C., so as to provide the amorphous silicon film with high annealing heat energy within a few seconds. The short duration of the transient high temperature pulses prevents from damaging the glass substrate. However, comparing the near-UV photons emitted from excimer lasers, the absorption of near-IR photons emitted by the tungsten halogen lamp is poor due to the low absorption coefficients of all the amorphous silicon film layer, silicon dioxide layer, and glass substrate. Therefore, the annealing effects generated by directly irradiating near-IR photons towards the amorphous silicon film layer in the conventional rapid thermal annealing (RTA) and pulsed rapid thermal annealing (PRTA) processes are not effective.

Some research papers published by research institutes adopting the PRTA process are listed as follows:

1) Poly silicon film formation by nickel-induced-lateral-crystallization and pulsed rapid thermal annealing (T. C. Leung, C. F. Cheng, and M. C. Poon, Electron Devices Meeting, 2001 Proceedings, 2001 IEEE Hong Kong, 93-96)

2) TFT fabrication on MILC polysilicon film with pulsed rapid thermal annealing (C. Y Yuen, M. C. Poon, M. Chan, W. Y. Chan, and M. Qin, Electron Devices Meeting, 2000 Proceedings, 2000 IEEE Hong Kong, 72-75);

3) Polycrystalline silicon formation by pulsed rapid thermal annealing of amorphous silicon (Yeu Kuo and P. M. Kozlowski, Appl. Phys. Lett. 69 (8), 19 Aug. 1996, 1092-1094);

4) Polycrystalline silicon films prepared by improved pulsed rapid thermal annealing (Yuwen Zhao, Wenjing Wang, Feng Yun, Ying Xu, Xianbo Liao, Zhixun Ma, Guozhen Yue, and Guanglin Kong, Solar Energy Materials & Solar Cells 62 (2000) 143-148);

5) Solid-phase crystallization and dopant activation of amorphous silicon films by pulsed rapid thermal annealing (Yongqian Wang, Xianbo Liao, Zhixun Ma, Guozhen Yue, Hongwei Diao, Jie He, Guanglin Kong, Yuwen Zhao, Zhongming Li, and Feng Yun, Applied Surface Science 135 (1998) 205-208); and

6) Structural properties of polycrystalline silicon films formed by pulsed rapid thermal processing (Yongqian Wang, Xianbo Liao, Hongwei Diao, Jie He, Zhixun Ma, Guozhen Yue, Shuran Sheng, Guanglin Kong, Yuwen Zhao, Zhongming Li, and Feng Yun, Mat. Res. Soc. Symp. Proc. Vol. 507 (1998) 975-980).

Research papers 1) and 2) above are related to pulsed rapid thermal annealing process. The experiments described in these papers deposit an amorphous silicon film above a crystalline silicon (C—Si) substrate. Between the C—Si substrate and the amorphous silicon film layer is added with a silicon dioxide buffer layer. Above the amorphous silicon film layer is sputtered with a nickel layer, which is etched with specific pattern, serving to induce crystallization. A tungsten halogen lamp is used to irradiate near-IR photons towards the surface of amorphous silicon film in a pulsed mode. The two research papers adopt the conventional rapid annealing process, that the film to be annealed, which is amorphous silicon film at here, is directly illuminated by the photons emitted from the light source, which is tungsten halogen lamp at here, and the film is annealed by absorbing the energy of the incident photons. However, the absorption of near-IR photons emitted by the tungsten halogen lamp is poor due to the low absorption coefficients of all the amorphous silicon film layer, silicon dioxide layer, and glass substrate. In fact, the primary energy for transforming the amorphous silicon film into the polysilicon film is the heat released by the C—Si substrate that effectively absorbs the near-IR photons emitted by the tungsten halogen lamp, but not a result of effectively annealing the amorphous silicon film layer into polysilicon by the film directive absorption of the irradiation of the light source. Further, the C—Si substrate fails to meet the needs for integrating the above-mentioned low temperature polysilicon into a glass or plastic substrate.

Research papers 3) to 6) are related to pulsed rapid thermal annealing process. The experiments described in these papers deposit an amorphous silicon film layer above a glass substrate. (In the third paper, between the amorphous silicon film layer and the glass substrate are added with a silicon nitride layer. Above the amorphous silicon film layer is sputtered with a thin metal layer, which is etched with specific pattern, for inducing the crystallization.) A C—Si holder supports the glass substrate and takes temperature measurements. A tungsten halogen lamp is used to directly irradiate near-IR photons towards the surface of the amorphous silicon film in a pulsed mode. As the research papers 1) and 2), these four research papers still adopt the conventional rapid annealing process, where the near-infrared photons emitted by the tungsten halogen lamp directly irradiate towards the sample. In fact, due to the low absorption coefficients of the amorphous silicon film layer, silicon nitride layer, and glass substrate with respect to the near-IR photons, the primary energy for transforming the amorphous silicon film into the polysilicon film is the heat released by the C—Si holder that effectively absorbs the near-IR photons emitted by the tungsten halogen lamp, but not a result of effectively annealing the amorphous silicon film layer into polysilicon by the film directive absorption of the irradiation of the light source. Further, the heat released by the C—Si holder must be first conducted by the glass substrate before reaching the amorphous silicon film layer. Hence, in the conventional pulsed rapid thermal annealing process disclosed in these four research papers, the heat will first be transferred to the glass before reaching the amorphous silicon film layer such that the glass substrate may be easily damaged while being subjected to high temperature pulses.

The pulsed rapid thermal annealing processes adopted by the prior art are all related to the conventional rapid annealing process, where the near-IR photons emitted by the tungsten halogen lamp are directly irradiated towards the sample. The low absorption coefficient of the amorphous silicon film layer with respect to the near-IR photons emitted by the tungsten halogen lamp results in poor absorption effects. As such, the temperature of the amorphous silicon film layer is not elevated by the irradiation of the near-IR photons, but in fact, by the heat released from the C—Si substrate or C—Si holder that absorbs the near-IR photons emitted by the tungsten halogen lamp. If the C—Si substrate or holder is not used, the amorphous silicon film layer cannot be effectively annealed into polysilicon film by directly irradiating the near-IR photons towards the sample. Further, the C—Si substrate fails to meet the needs for integrating the above-mentioned low temperature polysilicon into a glass or plastic substrate.

In view of the disadvantages of the conventional pulsed rapid thermal annealing process, this invention discloses a rapid energy transfer annealing device and process, in which an annealing process that does not adopt the direct irradiation of photons emitted by a light source towards the sample but allows rapid and effect energy transfer is disclosed. The process is also capable of independently controlling the temperature elevation of the amorphous silicon film layer and the heat dissipation of the glass or plastic substrate while achieving rapid annealing crystallization of the amorphous silicon film layer and preventing from damaging the glass or plastic substrate at the same time.

### SUMMARY OF INVENTION

It is an object of this invention to provide a rapid energy transfer annealing device and process allowing easy and large-area fabrication and capable of effectively rapidly annealing the amorphous silicon film layer into crystallization and preventing damaging the glass or plastic substrate under by high temperature.

According to the rapid energy transfer annealing device of this invention, an energy plate and a heat sink plate are implemented. The energy plate is capable of rapidly and -effectively absorbing a light source energy, rapidly elevating temperature, and rapidly releasing heat to be transferred to amorphous silicon film deposited above a glass or plastic substrate by means of a gas or solid medium through conduction, convection, or radiation, so as to serve as heat energy source for annealing the amorphous silicon film into a polysilicon film. The heat sink plate is capable of absorbing heat of the glass substrate through the gas or solid medium by conduction, convection, or radiation, so as to effectively reduce the glass substrate temperature and to protect the glass substrate from damages due to overheating.

The structure of the rapid energy transfer annealing device and the details of the process can be fully understood by referring to the detailed descriptions in accompaniment of the following drawings.

### DESCRIPTIONS OF INVENTION

It is an object of this invention to provide a rapid energy transfer annealing device and process having an energy plate capable of rapidly and effectively absorbing a light source energy, rapidly elevating temperature, and rapidly releasing heat to be transferred to amorphous silicon film deposited above a glass substrate by means of a gas or solid medium through conduction, convection, or radiation, so as to serve as heat energy source for annealing the amorphous silicon film into a polysilicon film.

It is another object of this invention to provide a rapid energy transfer annealing device and process having a heat sink plate capable of protecting the glass substrate from damages due to overheating.

It is a further object of this invention to provide a rapid energy transfer annealing device and process having an energy plate where its distance with respect to the amorphous silicon film can be fixed or varied as a function of time so as to randomly adjust the energy transferred to the amorphous silicon film.

It is a further object of this invention to provide a rapid energy transfer annealing device and process where the distance between the glass substrate and the heat sink plate may be fixed or varied as a function of time so as to control the energy released from the glass substrate to the heat sink plate.

It is a further object of this invention to provided a rapid energy transfer annealing device and process that implements a linear movement apparatus for passing the amorphous silicon film, glass substrate, and heat sink plate above or below the energy plate sequentially thereby controlling the annealing heat absorbed by the amorphous silicon film layer from the energy plate in a scanning mode.

It is yet a further object of this invention to provide a rapid energy transfer annealing device and process that implements a heat conducting layer, a heat shielding layer, a heat absorption layer, or a heat sink layer to allow selective crystallization or to guide the crystallization to grow in a specific direction.

### BRIEF DESCRIPTION OF DRAWINGS

FIG. 1 is a schematic drawing of a first embodiment of the rapid energy transfer annealing device according to this invention.

FIG. 2 is a schematic drawing of a second embodiment of the rapid energy transfer annealing device according to this invention.

FIG. 3 is a schematic drawing of a third embodiment of the rapid energy transfer annealing device according to this invention.

FIG. 4 is a schematic drawing of a sample for a fourth embodiment of the rapid energy transfer annealing device according to this invention.

FIG. 5A is a cross-section transmission electron microscopy (TEM) image of an N-type phosphorous dopant activation sample obtained from an experiment performed in the first embodiment of this invention prior to annealing.

FIG. 5B is a cross-section transmission electron microscopy (TEM) image of an N-type phosphorous dopant activation sample obtained from an experiment performed in the first embodiment of this invention subsequent to annealing.

FIG. 6A is a cross-section transmission electron microscopy (TEM) image of a hydrogenated amorphous silicon sample obtained from an experiment performed in the first embodiment of this invention prior to annealing.

FIG. 6B is a cross-section transmission electron microscopy (TEM) image of a hydrogenated amorphous silicon sample obtained from an experiment performed in the first embodiment of this invention subsequent to annealing.

### DETAILED DESCRIPTIONS OF PREFERRED EMBODIMENTS

The following descriptions of this invention should be referred to the accompanying drawings. Persons skilled in the art should realize that the following descriptions are provided for exemplary purposes rather than limiting the scope of this invention.

By referring to the descriptions with respect to the conventional processes, to improve the disadvantages of the various conventional processes, this invention discloses a novel rapid energy transfer annealing device and process that implements a process distinguishable from the various conventional processes to obtain a controllable rapid energy transfer annealing device and process. The fabrication of the components, in fact, are not necessarily be fabricated by completely complying with the descriptions of the preferred embodiments. Persons skilled in the art should be able to make modifications and changes without departing the spirits and scope of this invention.

### The First Embodiment

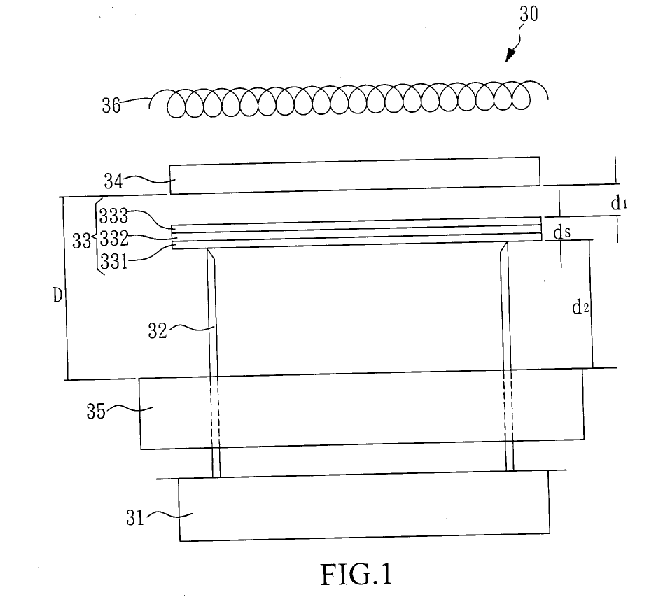

FIG. 1 is a schematic drawing of a first embodiment of the rapid energy transfer annealing device 30 according to this invention. The device 30 comprises a plurality of quartz pillars 32 affixed on a supporting plate 3 1; a sample 33 supported by the plurality of quartz pillars 32 and having a thickness of d_{S}, the sample 33 including a glass substrate 331, a silicon dioxide layer 332 and an amorphous silicon film layer 333 sequentially deposited above the glass substrate 331; an energy plate 34 provided above the sample 33 at a first distance d₁; a heat sink plate 35 provided below the sample 33 at a second distance d₂ and allowing the plurality of quartz pillars 32 to pass through, such that the supporting plate 31 is capable of vertical movement; and a tungsten halogen lamp 36 provided above the energy plate 34 to supply photon energy required by the energy plate 34. The energy plate 34 is selected from the group consisting of graphite, molybdenum, C—Si, and other materials capable of rapidly absorbing energy of the tungsten halogen lamp 36 capable of rapid temperature elevation.

In the rapid energy transfer annealing device 30 of this embodiment, the tungsten halogen lamp 36 directly irradiates photons towards the energy plate 34 from the top side in a pulsed or a non-pulsed mode. The positions of the supporting plate 31 and heat sink plate 35 are displaceable such that the first distance d₁ and the second distance d₂ may be fixed or varied as a function of time during the annealing process, so as to randomly control the heat absorption of the amorphous silicon film and the heat dissipation of the glass substrate. In conduction, the heat transfer is described by the formula of flux of heat energy, Jₕ₁=Kₜₕ₁(Tₑ−Tₛ₁)/d₁, wherein Jₕ₁ (W/cm²) is the heat flux transferred to an upper surface of the amorphous silicon film layer 333 from the lower surface of the energy plate 34 through the first distance d₁ by means of conduction, Kₜₕ₁ (W/cm ° C.) is the thermal conductivity of the gas or solid medium between the lower surface of the energy plate 34 and the upper surface of the amorphous silicon film layer 333 with the first distance d₁, Tₑ is the temperature of the lower surface of the energy plate 34, Tₛ₁ is the temperature of the upper surface of the amorphous silicon film layer 333. The four parameters, Kₜₕ₁, T_{c}, Tₛ₁, and d₁ determine the energy amount transferred from the lower surface of the energy plate 34 to the upper surface of the amorphous silicon film layer 333. For the first distance d₁, the lower the first distance d₁ is, the higher the energy transfer is. When d₁ approaches zero, the energy transfer is the maximum value. When d₁ approaches infinity, the energy transfer is the minimum value and Jₕ₁ approaches zero. Hence, adjustment of the first distance d₁ can effectively control the heat energy transferred from the lower surface of the energy plate 34 to the upper surface of the amorphous silicon film layer 333 between the maximum value and the minimum value, subjecting the amorphous silicon film layer 333 to transform into a polysilicon film layer. The silicon dioxide heat shielding layer 332 serves as heat shielding to prevent the glass substrate 331 from damages due to overheating (exceeding 600° C.) and softening. The heat sink plate 35 provided below the sample 33 at the second distance d₂ may of heat sink plate at a constant temperature far below the temperature of the energy plate 34, such as 25, 100, 200, or 300° C. Similarly, in conduction, the heat transfer is described in the formula of flux of heat energy, Jₕ₂=Kₜₕ₂(Tₛ₂−T_{b})/d₂, wherein Jₕ₂ (W/cm²) is the heat flux transferred from the lower surface of the glass substrate 331 to the upper surface of the heat sink plate 35 through the second distance d₂, Kₜₕ₂ (W/cm ° C.) is the thermal conductivity of the gas or solid medium between the glass substrate 331 and the upper surface of the heat sink plate 35 within the second distance d₂, Tₛ₂ is the temperature of the lower surface of the glass substrate 331, and T_{b} is the temperature of the upper surface of the heat sink plate 35. The four parameters, Kₜₕ₂, Tₛ₂, T_{b}, and d, determine the energy amount transferred from the lower surface of the glass substrate 331 to the upper surface of the heat sink plate 35. For the second distance d₂, the smaller the second distance d₂ is, the higher the energy transfer is. When d₂ approaches zero, the energy transfer is the maximum value. When d₂ approaches infinity, the energy transfer is the minimum value and Jₕ₂ approaches zero. Hence, adjustment of the second distance d₂ can effectively control the energy transferred from the lower surface of the glass substrate 331 to the upper surface of the heat sink plate 35 between the maximum value and the minimum value so as to prevent the glass substrate 331 from damages due to over heating. The parameters, including the area, thickness, material and quantities of the energy plate 34, the peak wavelength, intensity, the periods of the pulsed or non-pulsed rapid irradiation of the tungsten halogen lamp, the first distance d₁ between the energy plate 34 and the sample 33, the second distance d₂ between the sample 33 and the heat sink plate 35, the medium and draft, temperature and pressure of the medium between each two elements, the area, thickness, temperature and quantities of the heat sink plate 35, are inter-related and inter-dependent. Step-by-step adjustments and calibrations may be made by experiments so as to obtain the optimum annealing crystallization effects.

### The Second Embodiment

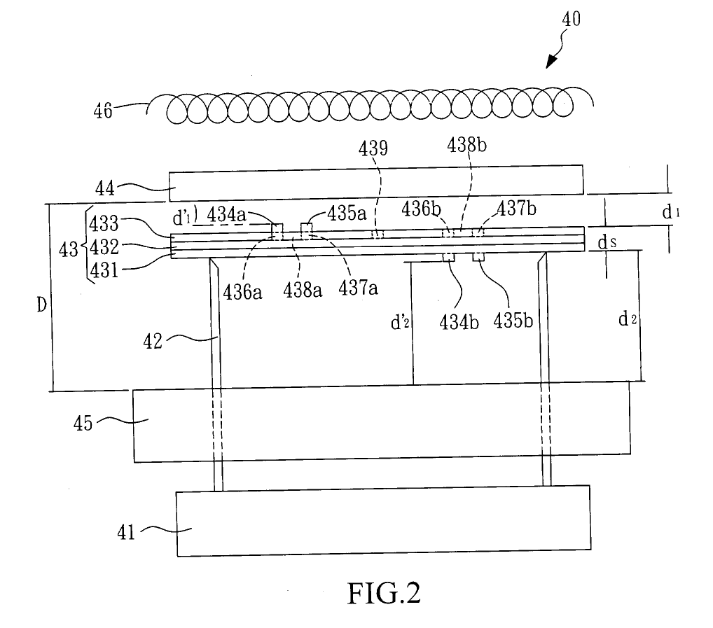

FIG. 2 is a schematic drawing of a second embodiment of the rapid energy transfer annealing device 40 according to this invention. The device 40 comprises a tungsten halogen lamp 46; a sample 43 having a thickness of d_{S}, the sample including a glass substrate 431, a silicon dioxide layer 432 and a amorphous silicon film layer 433 sequentially deposited above the glass substrate 431; an energy plate 44 provided above the sample 43 at a first distance d₁; and a heat sink plate 45 provided below the sample 43 at a second distance d₂. The overall structure of this embodiment is substantially the same as that of the rapid energy transfer annealing device 30 of the first embodiment. The first distinguishable feature is a first high relief 434a on the amorphous silicon film layer 433. The protrusion of the first high relief 434a subjects its distance d₁′ with respect to the energy plate 44 is less than the first distance d₁ between the amorphous silicon film layer 433 and the energy plate 44. As such, the first high relief 434a is subjected to more heat such that a first amorphous silicon film layer region 436a located below the first high relief 434a absorbs more energy than a seventh amorphous silicon film layer region 439 does. Similarity, a second amorphous silicon film layer region 437a located beneath a second high relief 435a absorbs more energy than the seventh amorphous silicon film layer region 439. The additional energy absorbed by the first amorphous silicon film layer region 436a and the second amorphous silicon film layer region 437a is then conducted to a fifth amorphous silicon film layer region 438a located between the two regions. Therefore, the crystallization rate at the first amorphous silicon film layer region 436a, the second amorphous silicon film layer region 437a, and the fifth amorphous silicon film layer region 438a are higher than the seventh amorphous silicon film layer region 439 and other regions of the amorphous silicon film layer 433. The second distinguishable feature is a third high relief 434b on the glass substrate 431. As such, the distance d₂′ between third high relief 434b and the heat sink plate 45 is less than the second distance d₂between the glass substrate 431 and the heat sink plate 45, whereby the third high relief 434b dissipates more heat energy. Similarly, a fourth high relief 435b dissipates more heat energy. Hence, the heat dissipation rate of a third amorphous silicon film layer region 436b located above the third high relief 434b and a fourth amorphous silicon film layer region 437b located above the fourth high relief 435b is higher than that of the seventh amorphous silicon film layer region 439; the heat dissipation rate at the third amorphous silicon film layer region 436b, the fourth amorphous silicon film layer region 437b, and a sixth amorphous silicon film layer region 438b between the two regions is higher than the seventh amorphous silicon film layer region 439 and other regions of the amorphous silicon film layer 433. Based on such features, the high reliefs on the amorphous silicon film layer 433 expedites heat absorption of the amorphous silicon film layer regions located below and neighboring the high reliefs thereby expediting temperature elevation, while the high reliefs on the glass substrate expedites the heat dissipation of the amorphous silicon film layer regions located above and neighboring the high reliefs thereby expediting temperature drop.

### The Third Embodiment

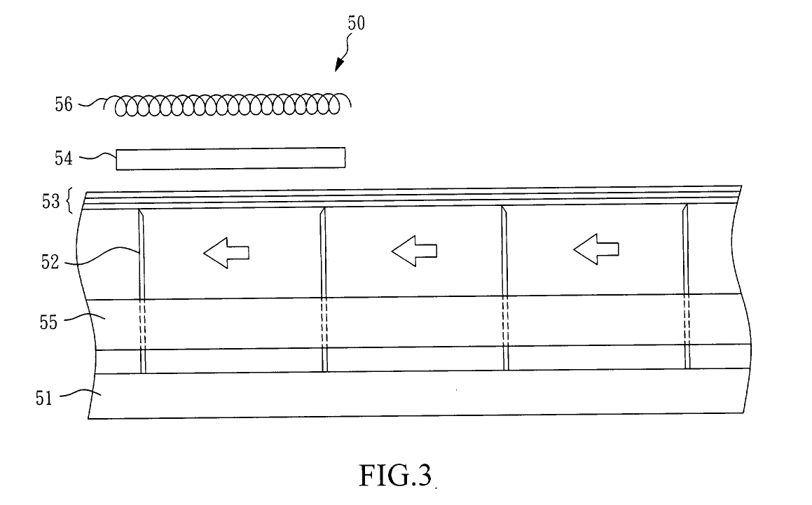

FIG. 3 is a schematic drawing of a third embodiment of the rapid energy transfer annealing device 50 according to this invention. The structure and application of the device 50 are substantially the same as those of the rapid energy transfer annealing device 30 of the first embodiment. The device 50 comprises a tungsten halogen lamp 56 and an energy plate 54 that are both stationary. The distinguishable features in FIG. 3 are that a heat sink plate 55, a plurality of quartz pillars 52 affixed on a supporting plate 5 1, a sample 53 supported by the plurality of quartz pillars 52, and a heat sink( plate 55 located below the sample 53 are all placed on a conveyor (not shown) so as to move leftwards simultaneously. Hence, the sample 53 may pass beneath the energy plate 54 along with the conveyor. By the heat scan released by the energy plate 54, the heat released by the energy plate 54 is rapidly absorbed so as to allow rapid temperature elevation. The heat sink( plate 55 and the supporting plate 51 can be vertically adjusted so as to obtain an annealing crystallization process similar to the rapid energy transfer annealing device 30 disclosed in the first embodiment.

### The Fourth Embodiment

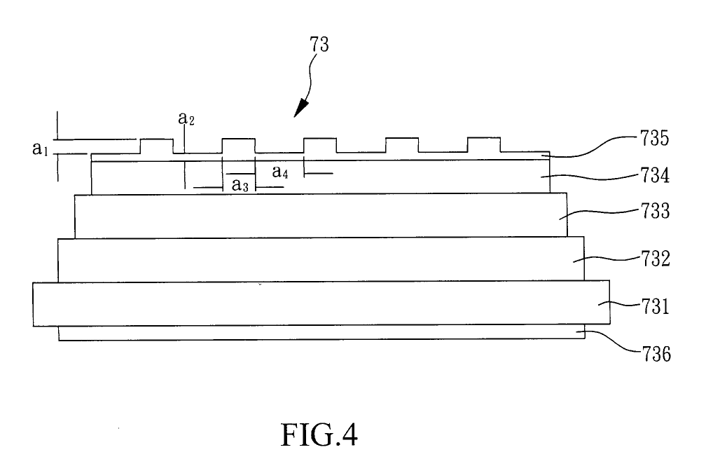

FIG. 4 is a schematic drawing of a sample 73 for a fourth embodiment of the rapid energy transfer annealing device according to this invention. The sample 73 includes a glass or plastic substrate 731. The substrate 731 is sequentially deposited there above with a heat conducting layer 732, such as metals; a heat shielding layer 733, such as silicon dioxide or silicon nitride; an amorphous thin film layer 734, such as an amorphous silicon; and a heat absorption layer 735. The substrate 731 is further sequentially deposited there below with a heat sink layer 736, such as metals. The heat conducting layer 732, the heat shielding layer 733, and the heat sink layer 736 may be continuous films, strips, grids, or films of other geometrical patterns. The amorphous thin film layer 734 may also be a continuous film, strips, grids, or a film of other geometrical patterns. The heat absorption layer 735 may be the geometrical patterns illustrated in FIG. 4, wherein the dimensions of a₁, a₂, a₃, and a₄ may be varied freely to adjust the degree of heating of various regions in the heat absorption layer 735, so as to allow selective crystallization. The geometrical patterns of the films may be applied freely, with the concepts that different thickness, heat conduction, and heat capacity may result in different rates of temperature elevation and temperature drop. Hence, the crystallization of the amorphous thin film layer 734 may be selected to take place in specific regions. The direction that the crystallization grows may also be guided by controlling the heat energy being transferred.

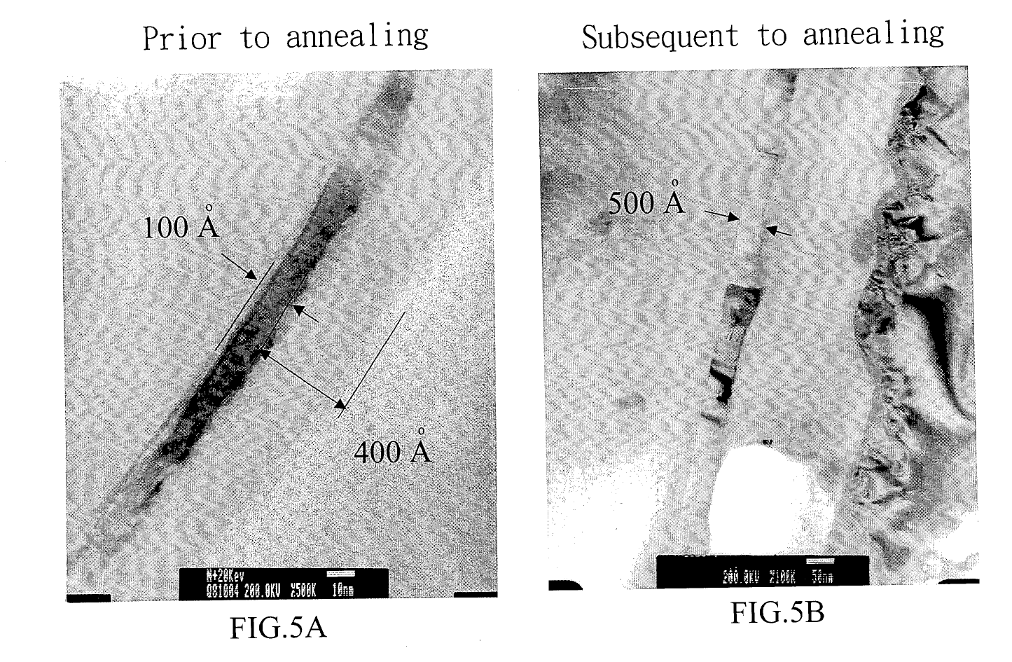

The rapid energy transfer annealing devices 30, 40, 50 described in the first to the third embodiments and the energy transfer annealing device sample 73 described in the fourth embodiment illustrate various applications of this invention in detail. The following first experimental results are obtained from implementing the first embodiment of this invention under the conditions, where the first distance d₁=2 mm; the second distance d₂=3 mm; a tungsten halogen lamp directly and rapidly irradiates towards the energy plate from the top side in a pulsed mode with a single pulse period being repeated for five times, and a single pulse period being set to elevate temperature from 400° C. to 900° C. in three seconds and maintained at 900° C. for five seconds, and then dropping from 900° C. to 400° C. in ten seconds, amounting to a pulse period of eighteen seconds. Next single pulse period immediately follows to repeat the period for five times, such that a total of only 90 seconds (18×5=90 seconds) is used to anneal an amorphous silicon film layer having a thickness of 400 angstroms into polysilicon and to activate the dopant, wherein the 400 angstroms amorphous silicon film layer is formed by colliding and impacting a low temperature polysilicon film having a thickness of 500 angstroms by N-type phosphorous ion implantation (Phosphorus: 20 keV, 1×10¹⁵/cm²). FIGS. 5A and 5B display the cross-section transmission electron microscopy (TEM) images of this N-type phosphorous dopant activation sample prior to and subsequent to annealing, respectively. The complete conversion of the amorphous silicon film layer into a polysilicon film layer subsequent to annealing can be easily observed. The sample consists of good conductivity with the sheet resistivity at approximately 280 Ω/square. Such an outcome of the good effects of dopant activation is equivalent to that resulted from the conventional laser annealing process.

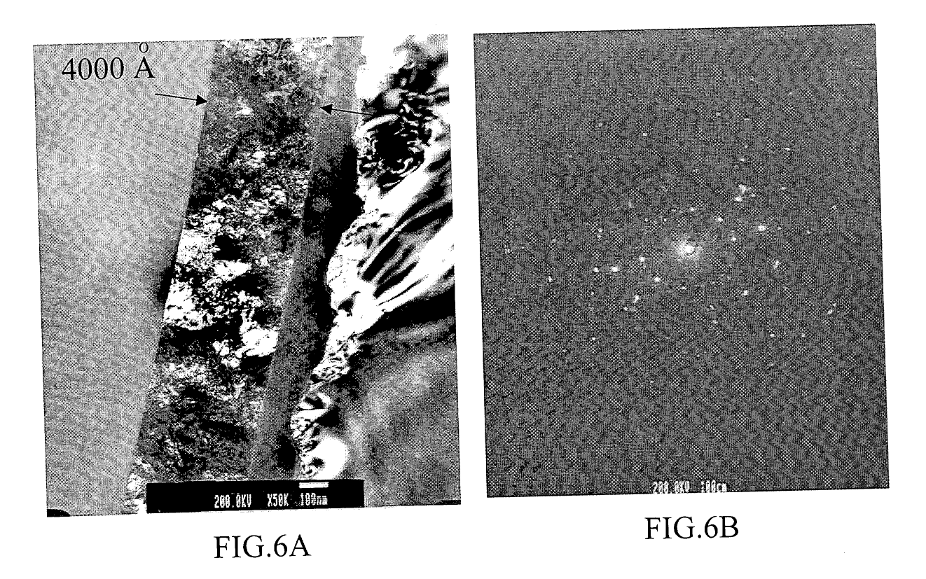

The following second experimental results are also obtained from implementing the first embodiment. A hydrogenated amorphous silicon film (a-Si:H) having a thickness of 4000 angstroms is deposited above a glass substrate. A total of 15 periods, 270 seconds (18×15=270 seconds) is used to anneal the hydrogenated amorphous silicon film into a polysilicon film without de-hydrogenation where hydrogen explosion is not observed. FIGS. 6A and 6B show the cross-section transmission electron microscopy (TEM) images of this hydrogenated amorphous silicon sample prior to and subsequent to annealing, respectively. One may easily observe complete conversion of the hydrogenised amorphous silicon film layer into a polysilicon film layer with an extremely smooth interface and diffraction patterns of polysilicon. Further, the rapid energy transfer annealing device of this invention may also adopt a feedback control system to freely adjust the temperature of the energy plate, such that the heating steps are not affected by the decays of the tungsten halogen lamp or other light sources. Further, the light source, the energy plate, the heat sink plate, and the supporting plate can all be assembled by numerous units to form a large-area construction so as to allow rapid and effective large-area rapid energy transfer annealing process, and is thus far more superior than the conventional processes.

The above embodiments are intended for describing this invention without limiting the scope that this invention may be applied. Modifications made in accordance with the disclosures of this invention without departing from the spirits of this invention are within the scope of this invention.

What is claimed is:

1. A rapid energy transfer annealing device, comprising:
a light unit for rapidly supplying primary photonic energy;
an energy unit, being a heat-absorption unit capable of rapidly absorbing the primary photonic energy of the light unit and rapid temperature elevation; and an annealing unit, including a substrate and an amorphous thin film deposited above the substrate, the amorphous thin film of the annealing unit facing the energy unit at a suitable distance;
wherein the amorphous thin film is transformed into a polycrystalline film with the rapid temperature elevation and heat release of the energy unit for heating the amorphous thin film.

2. The rapid energy transfer annealing device set forth in claim 1, further comprising a heat sink unit facing the substrate at a suitable distance.

3. The rapid energy transfer annealing device set forth in claim 1, wherein the distance between the annealing unit and the energy unit is selected from fixed, variable as a function of time, or zero.

4. The rapid energy transfer annealing device set forth in claim 2, wherein the distance between the annealing unit and the heat sink unit is selected from fixed, variable as a function of time, or zero.

5. The rapid energy transfer annealing device set forth in claim 1, wherein the light unit is selected from the group consisting of a single tungsten halogen lamp, a plurality of tungsten halogen lamps, a single xenon arc lamp, a plurality of xenon arc lamps, and a light source capable of supplying heat required by the energy unit;
wherein the energy unit is assembled by a single or a plurality of energy plates, the energy plates being selected from the groups consisting of graphite, molybdenum, C—Si, and any other materials capable of rapidly absorbing energy of the light unit; and
wherein the substrate is selected from the group consisting of a glass substrate, a plastic substrate, a quartz substrate, and any other suitable substrates.

6. The rapid energy transfer annealing device set forth in claim 2, wherein the heat sink unit assembled from the group consisting of a single thermostatic or temperature-controllable heat sink plate, a plurality of thermostatic or temperature-controllable heat sink plates; and
wherein the heat sink plates are selected from the group consisting of metals, semiconductors, insulators, and any other suitable heat sink materials.

7. The rapid energy transfer annealing device as set forth in claim 2, further comprising a holding unit and a supporting unit, the supporting unit having a first end being affixed to the holding unit and a second end contacting the substrate for supporting the annealing unit.

8. The rapid energy transfer annealing device as set forth in claim 1, further comprising:
a heat shielding layer, provided between the substrate and the amorphous thin film, the heat shielding layer being selected from the group consisting of silicon dioxide, silicon nitride, and any other suitable heat shielding materials;
a heat sink layer, provided on the substrate at another side of the amorphous thin film, the heat sink layer being selected from the group consisting of metals, semiconductors, insulators, and any other suitable heat sink materials; and
a heat conducting layer, provided between the substrate and the heat shielding layer, the heat conducting layer being selected from the group consisting of metals any other suitable heat conducting materials; and
a heat absorption layer, provided on the substrate at another side of the amorphous thin film, the heat absorption layer being selected from the group consisting of metals, semi-conductors, insulators, and any other suitable heat absorption materials.

9. The rapid energy transfer annealing device as set forth in claim 1, wherein the energy unit and the annealing unit are provided with a heat transfer medium selected from a solid medium, a gas medium, or solid and gas co-existed media there between.

10. The rapid energy transfer annealing device as set forth in claim 2, wherein the annealing unit and the heat sink unit are provided with a heat transfer medium selected from a solid medium, a gas medium, or solid and air co-existed media there between.

11. The rapid energy transfer annealing device as set forth in claim 1, wherein the annealing unit is movable by means of a conveyor unit, the amorphous thin film facing the energy unit being heated by the heat scan released by the energy unit so as to be transformed into a polycrystalline film.

12. A rapid energy transfer annealing process, comprising the steps of:
a. providing a light source, for rapidly releasing primary photonic energy;
b. providing an energy unit, being a heat-absorption unit capable of rapidly absorbing the primary photonic energy of the light unit and rapid temperature elevation; and
c. providing an annealing unit, including a substrate and an amorphous thin film deposited above the substrate, the amorphous thin film of the annealing unit facing the energy unit at an suitable distance, wherein the amorphous thin film is transformed into a polycrystalline film with the rapid temperature elevation and heat release of the energy unit for heating the amorphous thin film.
d. providing a heat sink unit, being a thermostatic or temperature-controllable heat sink unit located at a suitable distance from the annealing unit for absorbing energy released by the substrate.
